(19) United States
(12) Patent Application Publication
(10) Pub. No.: US 2024/0051207 A1
(43) Pub. Date: Feb. 15, 2024

(54) INJECTION DEVICE AND CONTROL METHOD

(71) Applicant: FANUC CORPORATION, Minamitsuru-gun, Yamanashi (JP)

(72) Inventors: Takuya OSAWA, Minamitsuru-gun, Yamanashi-ken (JP); Shoutarou SEKIGUCHI, Minamitsuru-gun, Yamanashi-ken (JP)

(21) Appl. No.: 18/273,189

(22) PCT Filed: Jan. 20, 2022
(86) PCT No.: PCT/JP2022/001947

§ 371 Date: Jul. 19, 2023

(30) Foreign Application Priority Data
Jan. 29, 2021 (JP) 2021-013460

(51) Int. Cl. B29C 45/76; B29C 45/50

(52) U.S. Cl. CPC B29C 45/76; B29C 45/5008; B29C 2045/504; B29C 2945/7602; B29C 2945/76214

(57) ABSTRACT

An injection device according to one embodiment of the present invention monitors the linear torque of a linear motor and the rotary torque of a rotary motor using a first detection unit for detecting the linear torque and a second detection unit for detecting the rotary torque while controlling the linear motor and the rotary motor so that a bush is spline-fitted to a screw.

### TECHNICAL FIELD

The present invention relates to an injection device and a control method.

### BACKGROUND ART

JP 2019-055488 A discloses a motor control unit that controls a linear motion motor and a rotational motion motor. The linear motion motor is a motor for moving a bush in the axial direction of a screw. The rotational motion motor is a motor for rotating the bush around the axis of the screw.

The motor control unit controls the linear motion motor to move the bush forward in a direction of approaching the screw from a state of being separated from the screw. When the torque of the linear motion motor has become equal to or greater than a first torque during the forward movement of the bush, the motor control unit controls the rotational motion motor to rotate the bush. Thereafter, the motor control unit stops the forward movement of the bush when a predetermined condition is satisfied. The predetermined condition is that the torque of the linear motion motor falls below a second torque smaller than the first torque before the rotation angle of the bush reaches 360 degrees, or that the torque of the linear motion motor does not fall below the second torque even after the rotation angle of the bush reaches 360 degrees or more.

### SUMMARY OF THE INVENTION

In JP 2019-055488 A, two cases are conceivable as a case where the torque of the linear motion motor becomes equal to or greater than the first torque. That is, the first case is a case where the spline shaft and the spline hole are not fitted to each other and the bush is in contact with the screw. The second case is a case where, when the bush fitted to the spline shaft continues to move forward and the spline shaft comes into contact with the bottom surface of the spline hole.

However, in JP 2019-055488 A, only the linear motion torque is monitored. Therefore, when the spline shaft comes into contact with the bottom surface of the spline hole and the torque becomes equal to or greater than the first torque, the bush is rotated by 360 degrees even when the spline fitting is completed. Therefore, the operation of rotating the bush goes to waste.

It is therefore an object of the present invention to provide an injection device and a control method capable of enhancing the working efficiency for spline fitting.

According to a first aspect of the present invention, there is provided an injection device including a screw disposed along a forward and rearward direction including a forward direction in which an injection resin is injected and a rearward direction opposite to the forward direction, and a bush formed so as to be spline-fitted to the screw, the injection device causing the screw and the bush to be spline-fitted to each other, the injection device further including: a linear motion motor configured to move the bush forward and rearward in the forward and rearward direction with respect to the screw; a rotary motor configured to rotate the bush with respect to the screw; a first detection unit configured to detect a linear motion torque of the linear motion motor; a second detection unit configured to detect a rotational torque of the rotary motor; and a motor control unit configured to execute a control process of controlling the linear motion motor and the rotary motor while monitoring the linear motion torque and the rotational torque in a manner so that the bush is spline-fitted to the screw.

According to a second aspect of the present invention, there is provided a control method executed by an injection device, the injection device including: a screw disposed along a forward and rearward direction including a forward direction in which an injection resin is injected and a rearward direction opposite to the forward direction; a bush formed so as to be spline-fitted to the screw; a linear motion motor configured to move the bush forward and rearward in the forward and rearward direction with respect to the screw; a rotary motor configured to rotate the bush with respect to the screw; a first detection unit configured to detect a linear motion torque of the linear motion motor; and a second detection unit configured to detect a rotational torque of the rotary motor, and in the control method, the injection device controls the linear motion motor and the rotary motor while monitoring the linear motion torque and the rotational torque in a manner so that the screw and the bush are spline-fitted to each other, the control method including: a rotation and forward movement step of moving the bush forward while rotating the bush with respect to the screw; a rotation stopping step of stopping rotation of the bush when the rotational torque exceeds a rotational torque threshold; and a forward movement stopping step of stopping forward movement of the bush when the linear motion torque exceeds a linear motion torque threshold.

According to a third aspect of the present invention, there is provided a control method executed by an injection device, the injection device including: a screw disposed along a forward and rearward direction including a forward direction in which an injection resin is injected and a rearward direction opposite to the forward direction; a bush formed so as to be spline-fitted to the screw; a linear motion motor configured to move the bush forward and rearward in the forward and rearward direction with respect to the screw; a rotary motor configured to rotate the bush with respect to the screw; a first detection unit configured to detect a linear motion torque of the linear motion motor; and a second detection unit configured to detect a rotational torque of the rotary motor, and in the control method, the injection device controls the linear motion motor and the rotary motor while monitoring the linear motion torque and the rotational torque in a manner so that the screw and the bush are spline-fitted to each other, the control method including: a rotation and forward movement step of alternately repeating a forward movement operation of moving the bush forward for a first specified time and a rotation operation of rotating the bush for a second specified time; a forward movement step of continuing to move the bush forward when the rotational torque exceeds a rotational torque threshold during the forward movement operation or the rotation operation; and a forward movement stopping step of stopping forward movement of the bush when the linear motion torque exceeds a linear motion torque threshold.

According to the aspects of the present invention, it is possible to grasp whether or not spline fitting is performed by monitoring not only the linear motion torque but also the rotational torque. Therefore, unnecessary rotation of the bush can be reduced, and as a result, the working efficiency for completing the spline fitting can be enhanced.

### BRIEF DESCRIPTION OF DRAWINGS

FIG. 1 is a schematic view showing an injection device according to an embodiment;

FIG. 2 is a view showing a screw and a bush;

FIG. 3 is a flowchart illustrating a first processing mode of control process executed by a motor control unit in order to perform spline-fitting of a screw to a bush;

FIG. 4 is a flowchart illustrating a second processing mode of the control process executed by the motor control unit in order to perform spline-fitting of the screw to the bush;

FIG. 5 is a view showing a screw and a bush according to a first modification;

FIG. 6 is a view showing a screw and a bush according to a second modification;

FIG. 7 is a view showing a screw and a bush according to a third modification;

FIG. 8A is a cross-sectional view of the screw of FIG. 7;

FIG. 8B shows a cross-section of the bush of FIG. 7; and

FIG. 9 is a view showing a screw and a bush according to a fourth modification.

### DETAILED DESCRIPTION OF THE INVENTION

### Embodiment

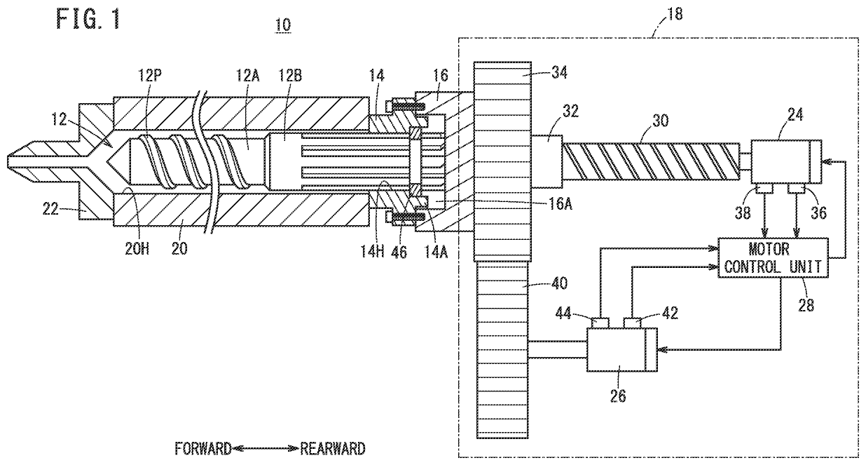

FIG. 1 is a schematic diagram illustrating an injection device 10 according to an embodiment. The injection device 10 injects a molding resin into a mold. In the present embodiment, an injection direction in which the molding resin is injected is a forward direction, and a direction opposite to the injection direction is a rearward direction. The injection device 10 includes a screw 12, a bush 14, a bush fastening portion 16, and a drive mechanism 18.

The screw 12 is accommodated in a through hole 20H of a cylinder 20. The screw 12 rotates to deliver, in the forward direction, the molding resin fed into the through hole 20H. The cylinder 20 includes, at a front end thereof, a nozzle 22, and the molding resin delivered by the screw 12 is injected from the nozzle 22. The screw 12 has a screw portion 12A and a spline portion 12B.

The screw portion 12A is a front portion of the screw 12. A helical protrusion 12P is formed on the outer peripheral surface of the screw portion 12A. The spline portion 12B is a rear portion of the screw 12 and is connected to a rear end of the screw portion 12A. The outer peripheral surface of the spline portion 12B is formed with concavities and convexities that can be spline-fitted to the bush 14.

The bush 14 is spline-fitted to the screw 12. The bush 14 has a through hole 14H extending therethrough in the forward and rearward direction. The inner peripheral surface of the through hole 14H is formed with concavities and convexities that can be spline-fitted to the spline portion 12B. The bush 14 is provided with an annular protrusion 14A protruding rearward from the rear end surface of the bush 14.

The bush fastening portion 16 is a member capable of fixing the bush 14. The bush fastening portion 16 has a recess 16A in which the protrusion 14A of the bush 14 is accommodated. The bush 14 is fixed to the bush fastening portion 16 by using bolts, and the protrusion 14A is housed in the recess 16A.

The drive mechanism 18 is a mechanism that drives at least one of the screw 12 or the bush 14 so as to move the bush 14 relative to the screw 12. In the present embodiment, the drive mechanism 18 drives the bush 14. The drive mechanism 18 includes a linear motion motor 24, a rotary motor 26, and a motor control unit 28.

The linear motion motor 24 is a motor that moves the bush 14 forward and rearward in the forward and rearward direction. A ball screw 30 is coupled to the motor shaft of the linear motion motor 24, and rotates together with the motor shaft. A sliding portion 32 is attached to the ball screw 30 such that the ball screw 30 can move forward and rearward in the forward and rearward direction in accordance with the rotation of the linear motion motor 24. A linear motion gear 34 is rotatably attached to the sliding portion 32. The linear motion gear 34 is fixed to the rear end of the bush fastening portion 16. The linear motion motor 24 is provided with an encoder 36 that detects a rotation angle of the linear motion motor 24 and a first detection unit 38 that detects a linear motion torque of the linear motion motor 24.

The rotary motor 26 is a motor that rotates the bush 14 with respect to the screw 12. A rotation gear 40 meshing with the linear motion gear 34 is coupled to the motor shaft of the rotary motor 26. The rotary motor 26 is provided with an encoder 42 for detecting a rotation angle of the rotary motor 26 and a second detection unit 44 for detecting a rotational torque of the rotary motor 26.

In the drive mechanism 18, when the linear motion motor 24 rotates, the linear motion gear 34 moves in the forward and rearward direction via the ball screw 30 and the sliding portion 32 in accordance with the rotation of the linear motion motor 24. In this case, the rotation gear 40 meshing with the linear motion gear 34 and the rotary motor 26 move in the forward and rearward direction, and the bush 14 moves in the forward and rearward direction via the bush fastening portion 16 to which the linear motion gear 34 is fixed. On the other hand, when the rotary motor 26 rotates, the rotation gear 40 rotates in accordance with the rotation of the rotary motor 26. In this case, the linear motion gear 34 meshing with the rotation gear 40 rotates, and the bush 14 rotates via the bush fastening portion 16 to which the linear motion gear 34 is fixed.

The motor control unit 28 controls the linear motion motor 24 such that the rotation angle detected by the encoder 36 becomes a target value, thereby moving the bush 14 forward and rearward with respect to the screw 12. The motor control unit 28 rotates the bush 14 by controlling the rotary motor 26 such that the rotation angle detected by the encoder 42 becomes a target value.

The motor control unit 28 executes a control process for controlling the linear motion motor 24 and the rotary motor 26 such that the bush 14 is spline-fitted to the screw 12. In this case, the motor control unit 28 controls the linear motion motor 24 and the rotary motor 26 while monitoring the linear motion torque detected by the first detection unit 38 and the rotational torque detected by the second detection unit 44.

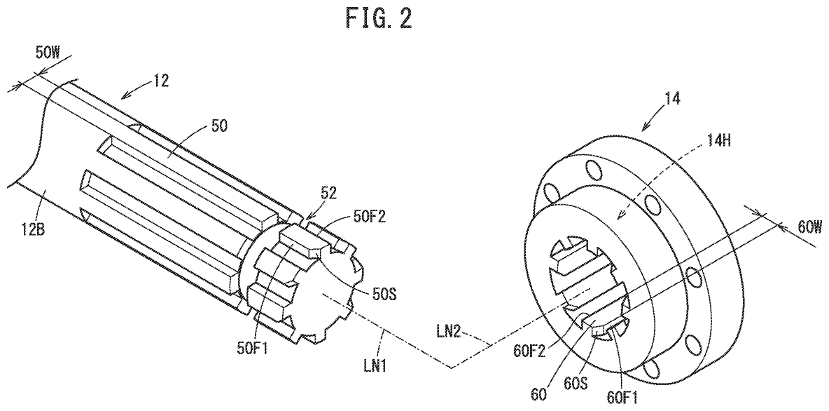

FIG. 2 is a view showing the screw 12 and the bush 14. The spline portion 12B includes a plurality of outer peripheral projections 50 formed on an outer peripheral surface of the spline portion. The projections 50 extend along the forward and rearward direction and are formed at intervals in the circumferential direction of the spline portion 12B. Each of the outer peripheral projections 50 is divided by a fitting groove 52 which extends along and around the circumferential direction of the spline portion 12B. An annular retainer 46 (FIG. 1) is fitted into the fitting groove 52.

The outer peripheral projections 50 have the same shape. Hereinafter, the shape of only one of the outer peripheral projections 50 will be described. An outer peripheral projection inclined surface 50S is formed at a rear end portion of one of both side surfaces 50F1 and 50F2 of the outer peripheral projection 50 in the circumferential direction of the screw 12. The outer peripheral projection inclined surface 50S is inclined such that an outer peripheral projection width 50W along the circumferential direction of the screw 12 becomes smaller toward the rear end.

The through hole 14H of the bush 14 includes a plurality of inner peripheral projections 60 formed on an inner peripheral surface of the through hole 14H. The inner peripheral projections extend along the forward and rearward direction and are formed at intervals in the circumferential direction of the through hole 14H. The inner peripheral projections 60 have the same shape. Hereinafter, the shape of only one of the inner peripheral projections 60 will be described. An inner peripheral projection inclined surface 60S is formed at a front end portion of one of both side surfaces 60F1 and 60F2 of the inner peripheral projection 60 in the circumferential direction of the through hole 14H. The inner peripheral projection inclined surface 60S is inclined such that an inner peripheral projection width 60W along the circumferential direction of the through hole 14H becomes smaller toward the front end.

Here, the control process executed by the motor control unit 28 for spline-fitting the screw 12 to the bush 14 will be described separately in a first processing mode and a second processing mode.

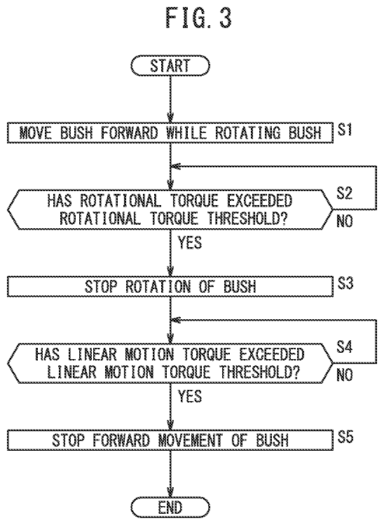

FIG. 3 is a flowchart showing the first processing mode of the control process executed by the motor control unit 28 for spline-fitting the screw 12 to the bush 14. This control process is started after the bush 14 has been moved to a predetermined fitting start position spaced apart from the rear end surface of the screw 12 in the rearward direction. At the fitting start position, it is desirable that the rotation center line LN1 (FIG. 2) of the screw 12 and the center line LN2 (FIG. 2) of the through hole 14H of the bush 14 coincide with each other, but the rotation center line LN1 and the center line LN2 may be slightly deviated from each other.

In step S1, the motor control unit 28 advances the bush 14 toward the screw 12 while rotating the bush 14. When the forward movement of the bush 14 is started, the control process proceeds to step S2.

In step S2, the motor control unit 28 compares the rotational torque detected by the second detection unit 44 with a predetermined rotational torque threshold. If the rotational torque does not exceed the rotational torque threshold, the control process remains at step S2. On the other hand, when the rotational torque exceeds the rotational torque threshold, the control process proceeds to step S3.

The situation in which the rotational torque exceeds the rotational torque threshold in step S2 occurs in the following state. That is, the state is a fitting state in which the screw 12 and the bush 14 are spline-fitted to each other or a guiding state in which the screw 12 and the bush 14 are guided so as to be spline-fitted to each other. Specifically, the guiding state is one of the following three states. The first one is a state in which the front end of the inner peripheral projection 60 of the bush 14 is in contact with the outer peripheral projection inclined surface 50S of the screw 12. The second one is a state in which the inner peripheral projection inclined surface 60S of the bush 14 is in contact with the rear end of the outer peripheral projection 50 of the screw 12. The third one is a state in which the inner peripheral projection inclined surface 60S of the bush 14 is in contact with the outer peripheral projection inclined surface 50S of the screw 12.

In step S3, the motor control unit 28 stops the rotation of the bush 14. When the rotation of the bush 14 is stopped, the control process proceeds to step S4.

In step S4, the motor control unit 28 compares the linear motion torque detected by the first detection unit 38 during the forward movement of the bush 14 with the linear motion torque threshold. If the linear motion torque does not exceed the linear motion torque threshold, the control process remains at step S4. On the other hand, when the linear motion torque exceeds the linear motion torque threshold, the control process proceeds to step S5.

The situation that the linear motion torque exceeds the linear motion torque threshold in step S4 occurs in the following state. That is, it is a state where the rear end surface of the screw 12 spline-fitted to the bush 14 is in contact with the bottom surface of the recess 16A of the bush fastening portion 16.

In step S5, the motor control unit 28 terminates the control process by stopping the forward movement of the bush 14 when the linear motion torque exceeds the linear motion torque threshold.

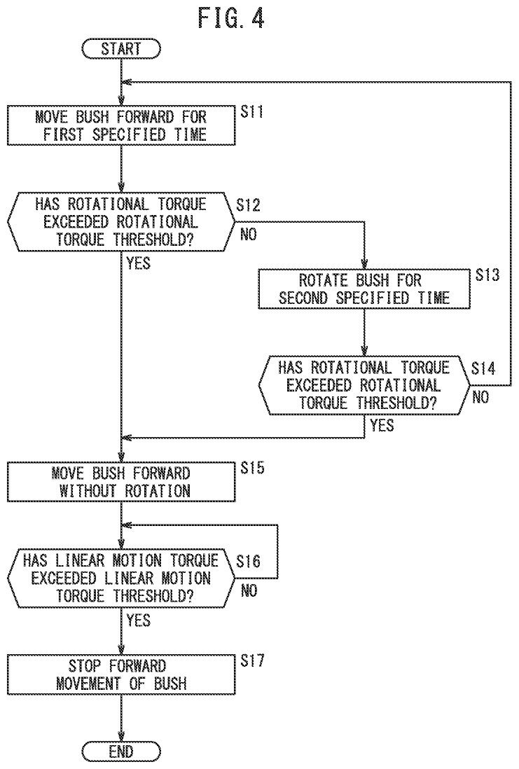

FIG. 4 is a flowchart showing the second processing mode of the control process executed by the motor control unit 28 for spline-fitting the screw 12 to the bush 14. This control process is started after the bush 14 has been moved to the fitting start position, as in the first processing mode. At the fitting start position, it is desirable that the rotation center line LN1 (FIG. 2) of the screw 12 and the center line LN2 (FIG. 2) of the through hole 14H of the bush 14 coincide with each other, but the rotation center line LN1 and the center line LN2 may be slightly deviated from each other.

In step S11, the motor control unit 28 starts a forward movement operation of moving the bush 14 forward for a first specified time. When the forward movement operation is started, the control process proceeds to step S12.

In step S12, the motor control unit 28 compares the rotational torque detected by the second detection unit 44 during the forward movement with the rotational torque threshold. If the rotational torque does not exceed the rotational torque threshold, the control process proceeds to step S13. On the other hand, when the rotational torque exceeds the rotational torque threshold, the control process proceeds to step S15.

In step S13, the motor control unit 28 starts the rotation operation of rotating the bush 14 for a second specified time at a position at which the forward movement operation has been ended. The second specified time may be the same as or different from the first specified time. When the rotation operation is started, the control process proceeds to step S14.

In step S14, the motor control unit 28 compares the rotational torque detected by the second detection unit 44 during the rotation operation with the rotational torque threshold. If the rotational torque does not exceed the rotational torque threshold, the control process returns to step S11. In this case, the motor control unit 28 starts the forward movement operation at the position (phase) at which the rotating operation has been ended. On the other hand, when the rotational torque exceeds the rotational torque threshold, the control process proceeds to step S15. It should be noted that the situation in which the rotational torque exceeds the rotational torque threshold at step S14 occurs in the fitting state. On the other hand, the situation in which the rotational torque exceeds the rotational torque threshold at step S12 occurs in the guiding state.

In step S15, the motor control unit 28 continues to move the bush 14 forward without rotating the bush 14. When the forward movement of the bush 14 is started, the control process proceeds to step S16.

In step S16, the motor control unit 28 compares the linear motion torque detected by the first detection unit 38 during the forward movement of the bush 14 with the linear motion torque threshold. If the linear motion torque does not exceed the linear motion torque threshold, the control process remains at step S16. On the other hand, when the linear motion torque exceeds the linear motion torque threshold, the control process proceeds to step S17. The situation in which the linear motion torque exceeds the linear motion torque threshold occurs in the state where the rear end of the spline-fitted screw 12 comes into contact with the bottom surface of the recess 16A of the bush fastening portion 16.

In step S17, the motor control unit 28 terminates the control process by stopping the forward movement of the bush 14 when the linear motion torque exceeds the linear motion torque threshold.

As described above, in both the first processing mode and the second processing mode, the motor control unit 28 executes the control process for controlling the linear motion motor 24 and the rotary motor 26 while monitoring the linear motion torque and the rotational torque such that the screw 12 and the bush 14 are spline-fitted to each other. Thus, it is possible to monitor not only the linear motion torque but also the rotational torque to determine whether or not the spline fitting is performed. Therefore, unnecessary rotation of the bush 14 can be reduced, and as a result, the working efficiency for spline fitting can be enhanced.

In the first processing mode, the motor control unit 28 moves the bush 14 forward while rotating the bush 14 with respect to the screw 12. The motor control unit 28 stops the rotation of the bush 14 when the rotational torque has exceeded the rotational torque threshold, and ends the control process when the linear motion torque exceeds the linear motion torque threshold. Accordingly, it is possible to suppress the rotation of the bush 14 after spline fitting.

In the second processing mode, the motor control unit 28 alternately repeats the forward movement operation and the rotation operation. When the rotational torque exceeds the rotational torque threshold during the forward movement operation or during the rotation operation, the motor control unit 28 continues to move the bush 14 forward. Thereafter, when the linear motion torque exceeds the linear motion torque threshold, the motor control unit 28 terminates the control process. Accordingly, similarly to the first processing mode, the rotation of the bush 14 after the spline fitting can be suppressed.

In a case where a plurality of forward operations are performed when the forward operation and the rotation operation are alternately repeated, the forward speeds of the forward operations may be the same or different. In addition, the forward speed of the forward movement operation when the forward movement operation and the rotation operation are alternately repeated may be the same as or different from the forward speed of the forward movement operation when the bush 14 is continuously moved forward without performing the rotating operation until the linear motion torque exceeds the linear motion torque threshold.

The outer peripheral projection inclined surface 50S is formed on each outer peripheral projection 50 on the outer peripheral surface of the rear end side of the screw 12. Further, each inner peripheral projection 60 on the inner peripheral surface of the front end side of the bush 14 is formed with the inner peripheral projection inclined surface 60S. Owing to the above configuration, in the following several states, spline fitting can be performed merely by moving the bush 14 forward without rotating the bush 14. One is a state in which the front end of the inner peripheral projection inclined surface 60S is in contact with the outer peripheral projection inclined surface 50S. Another one is a state in which the rear end of the outer peripheral projection inclined surface 50S is in contact with the inner peripheral projection inclined surface 60S. Still another one is a state in which the inner peripheral projection inclined surface 60S of the bush 14 is in contact with the outer peripheral projection inclined surface 50S of the screw 12. Therefore, the rotation of the bush 14 until the spline fitting is completed can be suppressed, as compared with a case where neither the outer peripheral projection inclined surface 50S nor the inner peripheral projection inclined surface 60S is formed.

### [Modifications]

The above embodiment may be modified as follows.

### (Modification 1)

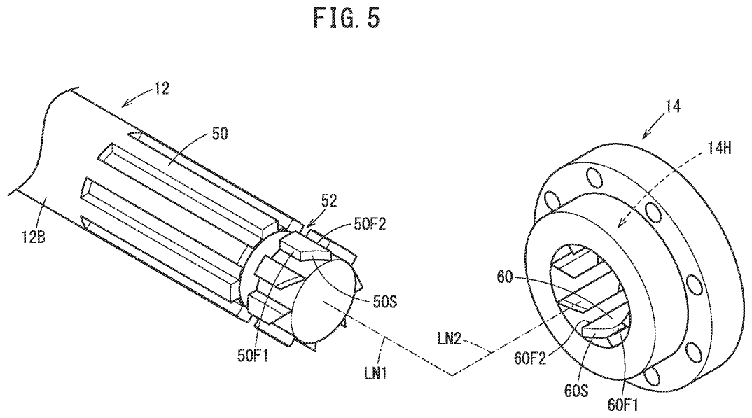

FIG. 5 is a view showing a screw 12 and a bush 14 according to a first modification. In FIG. 5, the same reference numerals are used to designate constituent elements that are the same as those described in the embodiment. Moreover, in the present modification, descriptions that overlap or are duplicative of those stated in the embodiment will be omitted.

In this modified example, the rear end of the outer peripheral projection 50 of the screw 12 and the front end of the inner peripheral projection 60 of the bush 14 do not have a flat surface. The rear end of the outer peripheral projection 50 and the front end of the inner peripheral projection 60 are formed in a pointed shape or a rounded shape. Owing to this configuration, it is possible to avoid a situation where the rear end surface of the outer peripheral projection 50 and the front end surface of the inner peripheral projection 60 come into contact with each other and the bush 14 consequently does not move forward. Therefore, it is possible to further enhance the certainty with which spline fitting can be performed, as compared with the embodiment. Further, the rotation of the bush 14 until the spline fitting is completed can be reduced.

### (Modification 2)

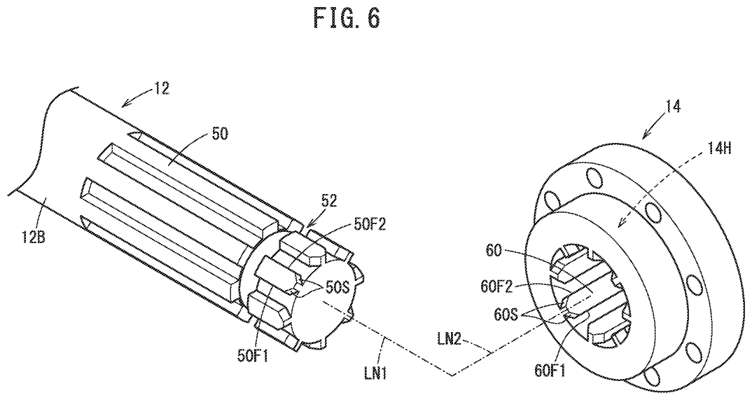

FIG. 6 is a view showing a screw 12 and a bush 14 according to a second modification. In FIG. 6, the same reference numerals are used to designate constituent elements that are the same as those described in the embodiment. Moreover, in the present modification, descriptions that overlap or are duplicative of those stated in the embodiment will be omitted.

In the present modification, the outer peripheral projection inclined surface 50S of the outer peripheral projection 50 is formed on each of both side surfaces 50F1 and 50F2 in the circumferential direction of the screw 12. In addition, the inner peripheral projection inclined surface 60S of the inner peripheral projection 60 is formed on each of both side surfaces 60F1 and 60F2 in the circumferential direction of the through hole 14H. Even in this modification, spline fitting can be performed merely by moving the bush 14 forward without rotating the bush in the case of the following state. To be more specific, it is a state where the front end of the inner peripheral projection inclined surface 60S is in contact with the outer peripheral projection inclined surface 50S. Alternatively, it is a state where the rear end of the outer peripheral projection inclined surface 50S is in contact with the inner peripheral projection inclined surface 60S. Alternatively, it is in a state where the inner peripheral projection inclined surface 60S is in contact with the outer peripheral projection inclined surface 50S. Therefore, the rotation of the bush 14 until the spline fitting is completed can be suppressed, as compared with the case where neither the outer peripheral projection inclined surface 50S nor the inner peripheral projection inclined surface 60S is formed.

### (Modification 3)

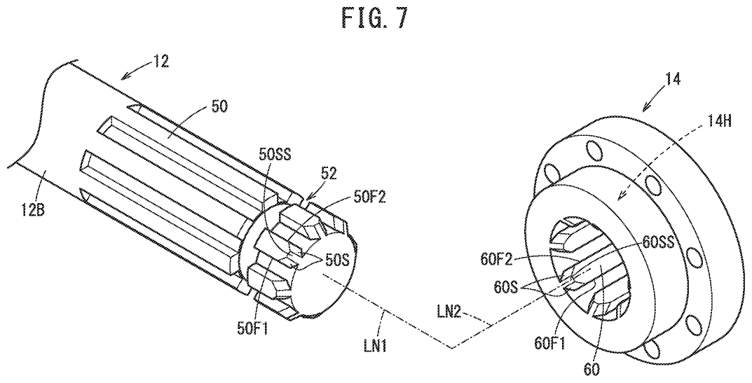

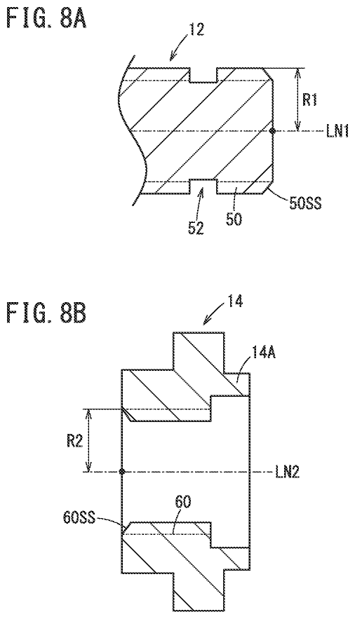

FIG. 7 is a view showing a screw 12 and a bush 14 according to a third modification. FIG. 8A is a cross sectional view of the screw 12 of FIG. 7. FIG. 8B is a cross sectional view of the bush 14 of FIG. 7. In FIGS. 7, 8A, and 8B, the same reference numerals are used to designate constituent elements that are the same as those described in the embodiment. Moreover, in the present modification, descriptions that overlap or are duplicative of those stated in the embodiment will be omitted.

In addition to the outer peripheral projection inclined surface 50S of the second modification, a second outer peripheral projection inclined surface 50SS is formed in the outer peripheral projection 50 of the present modification. The second outer peripheral projection inclined surface 50SS is inclined such that the outer diameter of the screw 12 gradually decreases toward the rear end of the outer peripheral projection 50. That is, the second outer peripheral projection inclined surface 50SS is inclined such that the radius R1 (FIG. 8A) of the screw 12 from the rotation center line LN1 of the screw 12 gradually decreases toward the rear end of the outer peripheral projection 50.

In addition to the inner peripheral projection inclined surface 60S of the second modification, a second inner peripheral projection inclined surface 60SS is formed on the inner peripheral projection 60 of the present modification. The second inner peripheral projection inclined surface 60SS is inclined such that the inner diameter of the bush 14 gradually increases toward the front end of the inner peripheral projection 60. In other words, the second inner peripheral projection inclined surface 60SS is inclined such that the radius R2 (FIG. 8B) of the through hole 14H from the center line LN2 of the through hole 14H gradually increases toward the front end of the inner peripheral projection 60.

Since the second outer peripheral projection inclined surface 50SS and the second inner peripheral projection inclined surface 60SS are formed, contact between the rear end surface of the outer peripheral projection 50 and the front end surface of the inner peripheral projection 60 is reduced. Therefore, a situation in which the bush 14 does not move forward is reduced. As a result, certainty with which the spline fitting can be performed is enhanced as compared with a case where neither the second outer peripheral projection inclined surface 50SS nor the second inner peripheral projection inclined surface 60SS is formed.

### (Modification 4)

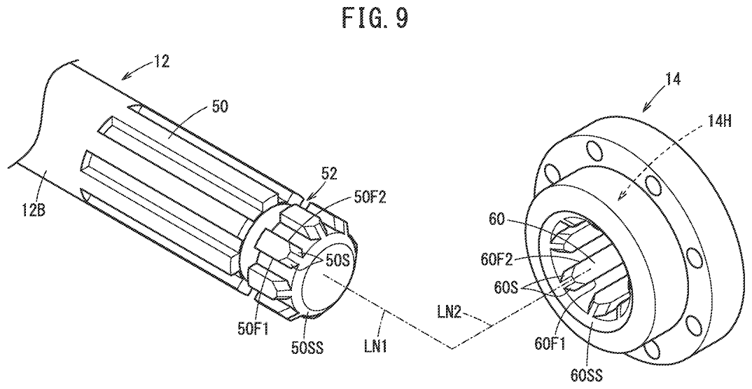

FIG. 9 is a view showing a screw 12 and a bush 14 according to a fourth modification. In FIG. 9, the same components as those described above are denoted by the same reference numerals. Moreover, in the present modification, descriptions that overlap or are duplicative of those stated in the above will be omitted.

In the present modification, the second outer peripheral projection inclined surface 50SS is formed not only on each of the outer peripheral projections 50 but also between the outer peripheral projections 50. Further, the second inner peripheral projection inclined surface 60SS is formed not only on each of the inner peripheral projections 60 but also between the inner peripheral projections 60. Thus, even if the center line LN2 of the through hole 14H of the bush 14 is displaced in the radial direction of the screw 12 with respect to the rotation center line LN1 of the screw 12, spline fitting can be performed by moving the bush 14 forward toward the screw 12.

The second outer peripheral projection inclined surface 50SS may be formed over the entire circumference around the axis of the screw 12 and from the side surface to the rear end surface of the screw 12 (see FIG. 9). Similarly, the second inner peripheral projection inclined surface 60SS may be formed over the entire circumference around the axis of the bush 14 and from the inner peripheral surface to the front end surface of the bush 14 (see FIG. 9). The second outer peripheral projection inclined surface 50SS may be formed only between the outer peripheral projections 50. Similarly, the second inner peripheral projection inclined surface 60SS may be formed only between the inner peripheral projections 60.

### (Modification 5)

The rear end of the outer peripheral projection 50 may be positioned on the same plane as the rear end surface of the screw 12, or may be positioned closer to the front end side than the rear end surface of the screw 12. That is, the rear end of the outer peripheral projection 50 in the embodiment, the first modification, the second modification, or the third modification may be positioned closer to the front end side than the rear end surface of the screw 12. In addition, the rear end of the outer peripheral projection 50 in the fourth modification may be positioned on the same plane as the rear end surface of the screw 12.

The front end of the inner peripheral projection 60 may be positioned on the same plane as the front end surface of the bush 14, or may be positioned closer to the rear end side than the front end surface of the bush 14. That is, the front end of the inner peripheral projection 60 in the embodiment, the first modification, the second modification, or the third modification may be located closer to the rear end side than the front end surface of the bush 14. Further, the front end of the inner peripheral projection 60 in the fourth modification may be located on the same plane as the front end surface of the bush 14.

### (Modification 6)

The second outer peripheral projection inclined surface 50SS and the second inner peripheral projection inclined surface 60SS may be formed with no outer peripheral projection inclined surface 50S or inner peripheral projection inclined surface 60S being formed. In addition, none of the outer peripheral projection inclined surface 50S, the inner peripheral projection inclined surface 60S, the second outer peripheral projection inclined surface 50SS, and the second inner peripheral projection inclined surface 60SS may be formed.

### (Modification 7)

The above-described embodiment and the modifications thereof may be optionally combined within a range in which no technical inconsistencies occur.

The above is summarized as follows.

A first invention is characterized by the injection device (10) including the screw (12) disposed along the forward and rearward direction including the forward direction in which an injection resin is injected and the rearward direction opposite to the forward direction, and the bush (14) formed so as to be spline-fitted to the screw, the injection device causing the screw and the bush to be spline-fitted to each other, the injection device (10) further including: the linear motion motor (24) configured to move the bush forward and rearward in the forward and rearward direction with respect to the screw; the rotary motor (26) configured to rotate the bush with respect to the screw; the first detection unit (38) configured to detect the linear motion torque of the linear motion motor; the second detection unit (44) configured to detect the rotational torque of the rotary motor; and the motor control unit (28) configured to execute the control process of controlling the linear motion motor and the rotary motor while monitoring the linear motion torque and the rotational torque such that the bush is spline-fitted to the screw.

Thus, it is possible to monitor not only the linear motion torque but also the rotational torque to determine whether or not the spline fitting is performed. Therefore, unnecessary rotation of the bush can be reduced, and as a result, the working efficiency for performing spline fitting can be enhanced.

The motor control unit may move the bush forward while rotating the bush with respect to the screw, the motor control unit may stop rotation of the bush in a case where the rotational torque exceeds a rotational torque threshold, and the motor control unit may end the control process when the linear motion torque exceeds the linear motion torque threshold.

Accordingly, it is possible to suppress the rotation of the bush after spline fitting.

The motor control unit may alternately repeat a forward movement operation of moving the bush forward for a first specified time and a rotation operation of rotating the bush for a second specified time, the motor control unit may continue to move the bush forward in a case where the rotational torque exceeds a rotational torque threshold during the forward movement operation or the rotation operation, and the motor control unit may end the control process when the linear motion torque exceeds the linear motion torque threshold.

Accordingly, it is possible to suppress the rotation of the bush after spline fitting.

In a case where the rotational torque does not exceed the rotational torque threshold during the forward movement operation, the motor control unit may start the rotation operation at a position where the forward movement operation has been ended.

With this configuration, the forward movement operation can be quickly shifted to the rotation operation.

In a case where the rotational torque does not exceed the rotational torque threshold during the rotation operation, the motor control unit may start the forward movement operation at a phase where the rotation operation has been ended.

With this configuration, it is possible to quickly shift from the rotation operation to the forward movement operation.

The screw may include the outer peripheral projections (50) formed on the outer peripheral surface on the rear end side of the screw, the outer peripheral projections extending along the forward and rearward direction and being formed at intervals in the circumferential direction of the screw, each of the outer peripheral projections may be formed with the outer peripheral projection inclined surface (50S) inclined in a manner so that the outer peripheral projection width (50W) along the circumferential direction of the screw becomes smaller toward the rear end, the bush may include the through hole (14H) extending in the forward and rearward direction, and the inner peripheral projections (60) formed on an inner peripheral surface of the through hole, the inner peripheral projections extending in the forward and rearward direction and being formed at intervals in the circumferential direction of the through hole, and each of the inner peripheral projections may be formed with the inner peripheral projection inclined surface (60S) inclined in a manner so that the inner peripheral projection width (60W) along the circumferential direction of the through hole becomes smaller toward the front end.

With this configuration, when the front end of the inner peripheral projection inclined surface is in contact with the outer peripheral projection inclined surface, when the rear end of the outer peripheral projection inclined surface is in contact with the inner peripheral projection inclined surface, or when the inner peripheral projection inclined surface is in contact with the outer peripheral projection inclined surface, spline fitting can be performed merely by moving the bush forward without rotating the bush. Therefore, the rotation of the bush until the spline fitting is completed can be suppressed, as compared with a case where neither the outer peripheral projection inclined surface nor the inner peripheral projection inclined surface is formed.

The second outer peripheral projection inclined surface (50SS) inclined in a manner so that the outer diameter of the screw becomes smaller toward the rear end may be formed on the rear end side of the screw, and the second inner peripheral projection inclined surface (60SS) inclined in a manner so that the inner diameter of the bush becomes larger toward a front end may be formed on the front end side of the bush.

With this configuration, it is possible to reduce a situation in which the rear end surface of the outer peripheral projection and the front end surface of the inner peripheral projection come into contact with each other and the bush does not move forward. Therefore, it is possible to enhance certainty with which spline fitting can be performed as compared with a case where the second outer peripheral projection inclined surface and the second inner peripheral projection inclined surface are not formed.

The second outer peripheral projection inclined surface may be formed on each of the outer peripheral projections, and the second inner peripheral projection inclined surface may be formed on each of the inner peripheral projections.

With this configuration, it is possible to enhance certainty with which spline fitting can be performed.

The second outer peripheral projection inclined surface may be formed between the outer peripheral projections, and the second inner peripheral projection inclined surface may be formed between the inner peripheral projections.

With this configuration, it is possible to enhance certainty with which spline fitting can be performed.

A second invention is characterized by the control method executed by the injection device, the injection device including: the screw disposed along the forward and rearward direction including the forward direction in which an injection resin is injected and the rearward direction opposite to the forward direction; the bush formed so as to be spline-fitted to the screw; the linear motion motor configured to move the bush forward and rearward in the forward and rearward direction with respect to the screw; the rotary motor configured to rotate the bush with respect to the screw; the first detection unit configured to detect the linear motion torque of the linear motion motor; and the second detection unit configured to detect the rotational torque of the rotary motor, and in the control method, the injection device controls the linear motion motor and the rotary motor while monitoring the linear motion torque and the rotational torque in a manner so that the screw and the bush are spline-fitted to each other, the control method including: the rotation and forward movement step of moving the bush forward while rotating the bush with respect to the screw; the rotation stopping step of stopping rotation of the bush in a case where the rotational torque exceeds the rotational torque threshold; and the forward movement stopping step of stopping forward movement of the bush in a case where the linear motion torque exceeds the linear motion torque threshold.

Thus, it is possible to monitor not only the linear motion torque but also the rotational torque to determine whether or not the spline fitting is performed. Therefore, the rotation of the bush after the spline fitting can be suppressed, and as a result, the working efficiency for the spline fitting can be enhanced.

A third invention is characterized by the control method executed by the injection device, the injection device including: the screw disposed along the forward and rearward direction including the forward direction in which an injection resin is injected and the rearward direction opposite to the forward direction; the bush formed so as to be spline-fitted to the screw; the linear motion motor configured to move the bush forward and rearward in the forward and rearward direction with respect to the screw; the rotary motor configured to rotate the bush with respect to the screw; the first detection unit configured to detect the linear motion torque of the linear motion motor; and the second detection unit configured to detect the rotational torque of the rotary motor, and in the control method, the injection device controls the linear motion motor and the rotary motor while monitoring the linear motion torque and the rotational torque in a manner so that the screw and the bush are spline-fitted to each other, the control method including: the rotation and forward movement step of alternately repeating the forward movement operation of moving the bush forward for the first specified time and the rotation operation of rotating the bush for the second specified time; the forward movement step of continuing to move the bush forward in a case where the rotational torque exceeds the rotational torque threshold during the forward movement operation or the rotation operation; and the forward movement stopping step of stopping forward movement of the bush in a case where the linear motion torque exceeds the linear motion torque threshold.

Thus, it is possible to monitor not only the linear motion torque but also the rotational torque to determine whether or not the spline fitting is performed. Therefore, the rotation of the bush after the spline fitting can be suppressed, and as a result, the working efficiency for the spline fitting can be enhanced.

1. An injection device comprising a screw disposed along a forward and rearward direction including a forward direction in which an injection resin is injected and a rearward direction opposite to the forward direction, and a bush formed so as to be spline-fitted to the screw, the injection device causing the screw and the bush to be spline-fitted to each other, the injection device further comprising:
a linear motion motor configured to move the bush forward and rearward in the forward and rearward direction with respect to the screw;
a rotary motor configured to rotate the bush with respect to the screw;
a first detection unit configured to detect a linear motion torque of the linear motion motor;
a second detection unit configured to detect a rotational torque of the rotary motor; and
a motor control unit configured to execute a control process of controlling the linear motion motor and the rotary motor while monitoring the linear motion torque and the rotational torque in a manner so that the bush is spline-fitted to the screw.

2. The injection device according to claim 1, wherein
the motor control unit moves the bush forward while rotating the bush with respect to the screw, the motor control unit stops rotation of the bush when the rotational torque exceeds a rotational torque threshold, and the motor control unit ends the control process when the linear motion torque exceeds a linear motion torque threshold.

3. The injection device according to claim 1, wherein
the motor control unit alternately repeats a forward movement operation of moving the bush forward for a first specified time and a rotation operation of rotating the bush for a second specified time, the motor control unit continues to move the bush forward when the rotational torque exceeds a rotational torque threshold during the forward movement operation or the rotation operation, and the motor control unit ends the control process when the linear motion torque exceeds a linear motion torque threshold.

4. The injection device according to claim 3, wherein
when the rotational torque does not exceed the rotational torque threshold during the forward movement operation, the motor control unit starts the rotation operation at a position where the forward movement operation has been ended.

5. The injection device according to claim 3, wherein
when the rotational torque does not exceed the rotational torque threshold during the rotation operation, the motor control unit starts the forward movement operation at a phase where the rotation operation has been ended.

6. The injection device according to claim 1, wherein:
the screw includes a plurality of outer peripheral projections formed on an outer peripheral surface on a rear end side of the screw, the outer peripheral projections extending along the forward and rearward direction and being formed at intervals in a circumferential direction of the screw;
each of the outer peripheral projections is formed with an outer peripheral projection inclined surface inclined in a manner so that an outer peripheral projection width along the circumferential direction of the screw becomes smaller toward a rear end;
the bush includes a through hole extending in the forward and rearward direction, and a plurality of inner peripheral projections formed on an inner peripheral surface of the through hole, the inner peripheral projections extending in the forward and rearward direction and being formed at intervals in a circumferential direction of the through hole; and
each of the inner peripheral projections is formed with an inner peripheral projection inclined surface inclined in a manner so that an inner peripheral projection width along the circumferential direction of the through hole becomes smaller toward a front end.

7. The injection device according to claim 6, wherein:
a second outer peripheral projection inclined surface inclined in a manner so that an outer diameter of the screw becomes smaller toward the rear end, is formed on the rear end side of the screw; and
a second inner peripheral projection inclined surface inclined in a manner so that an inner diameter of the bush becomes larger toward the front end, is formed on a front end side of the bush.

8. The injection device according to claim 7, wherein:
the second outer peripheral projection inclined surface is formed on each of the outer peripheral projections; and
the second inner peripheral projection inclined surface is formed on each of the inner peripheral projections.

9. The injection device according to claim 7, wherein:
the second outer peripheral projection inclined surface is formed between the outer peripheral projections; and
the second inner peripheral projection inclined surface is formed between the inner peripheral projections.

10. A control method executed by an injection device,
wherein the injection device includes:
a screw disposed along a forward and rearward direction including a forward direction in which an injection resin is injected and a rearward direction opposite to the forward direction;
a bush formed so as to be spline-fitted to the screw;
a linear motion motor configured to move the bush forward and rearward in the forward and rearward direction with respect to the screw;
a rotary motor configured to rotate the bush with respect to the screw;
a first detection unit configured to detect a linear motion torque of the linear motion motor; and
a second detection unit configured to detect a rotational torque of the rotary motor, and
in the control method, the injection device controls the linear motion motor and the rotary motor while monitoring the linear motion torque and the rotational torque in a manner so that the screw and the bush are spline-fitted to each other, the control method comprising:
a rotation and forward movement step of moving the bush forward while rotating the bush with respect to the screw;
a rotation stopping step of stopping rotation of the bush when the rotational torque exceeds a rotational torque threshold; and
a forward movement stopping step of stopping forward movement of the bush when the linear motion torque exceeds a linear motion torque threshold.

11. A control method executed by an injection device,
wherein the injection device includes:
a screw disposed along a forward and rearward direction including a forward direction in which an injection resin is injected and a rearward direction opposite to the forward direction;
a bush formed so as to be spline-fitted to the screw;
a linear motion motor configured to move the bush forward and rearward in the forward and rearward direction with respect to the screw;
a rotary motor configured to rotate the bush with respect to the screw;
a first detection unit configured to detect a linear motion torque of the linear motion motor; and
a second detection unit configured to detect a rotational torque of the rotary motor, and
in the control method, the injection device controls the linear motion motor and the rotary motor while monitoring the linear motion torque and the rotational torque in a manner so that the screw and the bush are spline-fitted to each other, the control method comprising:
a rotation and forward movement step of alternately repeating a forward movement operation of moving the bush forward for a first specified time and a rotation operation of rotating the bush for a second specified time;
a forward movement step of continuing to move the bush forward when the rotational torque exceeds a rotational torque threshold during the forward movement operation or the rotation operation; and
a forward movement stopping step of stopping forward movement of the bush when the linear motion torque exceeds a linear motion torque threshold.
